(19) United States
(12) Patent Application Publication
(10) Pub. No.: US 2019/0327102 A1
(43) Pub. Date: Oct. 24, 2019

(54) SYSTEM AND METHOD FOR USE OF DIGITAL CURRENCY IN A COMMUNICATION NETWORK

(71) Applicants: Peter ASHWOOD-SMITH, Gatineau (CA); Wen TONG, Ottawa (CA)

(72) Inventors: Peter ASHWOOD-SMITH, Gatineau (CA); Wen TONG, Ottawa (CA)

(73) Assignee: Huawei Technologies Co., Ltd., Shenzhen (CN)

(21) Appl. No.: 15/957,277

(22) Filed: Apr. 19, 2018

(51) Int. Cl. H04L 12/14; H04L 12/851; G06Q 20/38; H04M 15/00

(52) U.S. Cl. CPC H04L 12/146; H04L 12/1425; H04L 47/2483; H04W 4/24; H04M 15/8016; H04M 15/8214; H04M 15/8285; G06Q 20/382

(57) ABSTRACT

A distributed payment system integrated in network resources allows for the distributed processing of digital currency transactions in existing network elements and allows for each node to act as a revenue source by charging for provided services. The systems and methods can provide a requesting entity the means for payment of use of the network resources of a provisioning entity. The network resources that are used can enable the provision of services that can include packet routing and forwarding, access to resources such an antennae and delivery of content.

### FIELD OF THE INVENTION

The present invention relates to methods and systems for using digital currencies in wired and wireless networking environments.

### BACKGROUND

In many data communication networks, there are a plurality of network operators that interconnect with each other. Traffic flows from one network to another allowing nodes in a first operator's domain to communicate with nodes in a second operator's domain. As networks grow more congested, typically, there is a disproportionate amount of traffic that one network operator receives from another (e.g. a first operator may be a video delivery service, while the second network is used to transport video content towards (or to) end users). To address the imbalance of traffic flows, peering arrangements have arisen that allow a first network operator to charge a fee to a second network operator to account for traffic imbalances. There is very little ability in conventional traffic peering agreements to provide granularity in service and billing.

Conventionally, peering or interchange agreements are denominated in conventional currencies and are based on bulk exchange of data that is projected over the term of the contract. As noted above, this does not lend itself to file grained billing, and will typically not allow for smaller participants to act as a paid relay.

Concurrently with the rise of large scale peering agreements, digital currencies such as BitCoin™ have arisen, and are often based on obtaining solutions to cryptographic challenges so that they can be verified in a distributed fashion without reliance upon a central authority. These currencies can also be known as cryptocurrencies. By being based digitally, such currencies can be subdivided to arbitrarily small units, thus lending themselves very well to use in micropayments.

As is known, proof of the validity of each cryptocurrency's coins can be provided, without resorting to a centralized authority, by a blockchain. A blockchain is a continuously growing list of records, termed blocks, which are linked and secured using cryptography. Each block contains a hash pointer as a link to a previous block, a timestamp and transaction data. By design, blockchains are inherently resistant to modification of the data. The blockchain is essentially an open distributed ledger that can record transactions between two parties in a verifiable and permanent way. For use as a distributed ledger, a blockchain is typically managed by a peer-to-peer network collectively adhering to a protocol for validating new blocks. Once recorded, the data in any given block cannot be altered retroactively without requiring the alteration of all subsequent blocks.

Many mechanisms that allow micropayments from a user to a content source have been proposed. Typically, these proposed solutions often rely on modifications to header fields that contain payer authorization which may be digitally signed and encrypted. These mechanisms are typically tied to deposit accounts which tie into existing currency systems. This requires that at least one of the parties to have funds held in reserve in a deposit account to pay for traffic or services before the traffic or services are consumed.

As networks become more distributed and as multiple new network models get introduced in both wired and wireless environments, new systems and methods for processing payments for traffic and services need to be provided to address deficiencies in the current art.

Accordingly, there may be a need for a system and method for use of digital currency in a communication network, that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present invention to obviate or mitigate at least one disadvantage of the prior art.

In accordance with an aspect of the present invention there is provided a method for reconciliation of use of resources of a network node. The method includes receiving by the network node, a request for use of network resources and performing by the network node, an action based at least in part on the request. The method further includes performing by the network node, a transaction of digital currency based on an associated cost for performance of the action.

According to some embodiments, the method further includes reconciling the associated cost with the performance of the action prior to performing the transaction. According to some embodiments, the method further includes distributing a fractional amount of received digital currency to a third party.

In accordance with an aspect of the present invention there is provided a network node including a processor and a non-transient memory for storing instructions that when executed by the processor cause the network node to be configured to receive a request for use of network resources and perform an action based at least in part on the request. The instructions when executed by the processor cause the network node to be further configured to perform a transaction of digital currency based on an associated cost for performance of the action.

In accordance with an aspect of the present invention there is provided a network function including a network interface for receiving data from and transmitting data to network functions connected to a network and a processor. The network function further including a non-transient memory for storing instructions that when executed by the processor cause the network function to be configured to receive a request for use of network resources and perform an action based at least in part on the request. The instructions when executed by the processor cause the network function to be further configured to perform a transaction of digital currency based on an associated cost for performance of the action.

According to some embodiments, the instructions, when executed by the processor further cause the network function or network node to be configured to reconcile the associated cost with the performance of the action prior to performing the transaction. According to some embodiments, the instructions, when executed by the processor further cause the network function or network node to be configured to distribute a fractional amount of received digital currency to a third party.

According to some embodiments, plural requests are received and plural actions are preformed in advance of performing the transaction. According to some embodiments, the request includes a data packet for transmission and wherein digital currency is embedded in a packet header of the data packet. According to some embodiments, the data packet is a portion of a data stream and wherein the digital currency is embedded in packet headers of data packets at predetermined locations within the data stream.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

In another aspect of the present invention there is provided a method of determining a Quality of Service (QoS) for a packet flow in a network. The method includes receiving a request for a QoS for an identified packet flow; receiving an allotment of digital currency associated with the identified packet flow; and instructing nodes within the network to provide the packet flow with a QoS determined in accordance with at least one of a determined pricing for the requested QoS and the allotment of digital currency.

In an embodiment of this aspect, the request for a QoS and the allotment of digital currency are received in the same message. In an embodiment, at least one of the request for a QoS and the allotment of digital currency are received in the header of a packet in the identified packet flow.

In an embodiment, the method further includes determining a pricing for the requested QoS in advance of instructing. Optionally the method may further include transmitting a notification that the received allotment is lower than the determined pricing. In a further embodiment, the method includes deducting digital currency from the allotment and transmitting a packet containing the remaining allotment towards a destination of the packet flow.

In another aspect, there is provided a method, for execution by an entity within a first network, of requesting a quality of service for a packet flow in a second network, different than the first network. The method includes transmitting, to a node in the second network, a request for a quality of service (QoS) for an identified packet flow; and transmitting, to the node in the second network, an allotment of digital currency associated with the request.

In an embodiment, the node in the second network is a gateway. In an embodiment, the node in the second network is within a control plane of the second network. In an embodiment, the request and the allotment are transmitted in the same packet. In a further embodiment, at least one of the request and the allotment are transmitted in a header of a packet in the identified packet flow.

In another embodiment, the method further includes receiving from a node in the second network pricing information associated with the QoS requested for the identified packet flow. Optionally, the method may further include transmitting at least one of a revised request for a QoS and a revised allotment of digital currency, and further optionally, the at least one of the revised request and the revised allotment are contained in an authorization message.

In other aspects of the present invention, there are provided network nodes having a network interface, a processor and a memory storing instructions that when executed by the processor configure the network node to carry out the methods described above.

It will be understood that the various embodiments described above may be implemented in conjunction with the aspect to which they have been described, but may also be implemented in conjunction with other embodiments of the same aspect, and in some cases may be implemented in conjunction with other aspects of the invention as well.

Other aspects and features of the present invention will become apparent to those ordinarily skilled in the art upon review of the following description of specific embodiments of the invention in conjunction with the accompanying figures.

### BRIEF DESCRIPTION OF THE FIGURES

Further features and advantages of the present invention will become apparent from the following detailed description, taken in combination with the appended drawings, in which:

FIG. 1 illustrates a method for use of resources of a network node and reconciliation for use of same, in accordance with embodiments of the present invention.

FIG. 2 is a block diagram of an electronic device within a computing and communications environment that may be used for implementing devices and methods in accordance with representative embodiments of the present invention.

FIG. 3 is a flow chart illustrating a method in accordance with an embodiment of the present invention that may be carried out at a node or function associated with a second network.

FIG. 4 is a flow chart illustrating a method in accordance with an embodiment of the present invention that may be carried out at a node or function associated with the source of a packet flow.

### DETAILED DESCRIPTION

The present disclosure is directed to systems and methods for using digital currencies in wired and wireless networking environments. The systems and methods can provide a requesting entity the means for payment of use of the network resources of a provisioning entity.

Generally, embodiments of the present invention disclosed below provide methods and systems for better addressing the role of digital currencies in communications networks.

One of the noted issues with digital currencies is that without the need for a central issuing authority, the number of digital currencies is not fixed. With a currency such as BitCoin™ that is based on cryptographically secure solutions, a distributed verification network is required. Creating this network from scratch can be a costly and time consuming enterprise, reducing the likelihood of a replacement cryptocurrency. This buy-in can be beneficial to the success of a first currency, but detrimental to the growth of a later created currency that may address technical deficiencies in the first. To address this, a mechanism to allow for the re-use of existing infrastructure may be desired. It should be understood that outside of a few select cases, the design of a node in a payment system will often lend itself to being efficiently re-used in a second payment system. Accordingly, in communication between nodes, a currency differentiation field can be included. This will allow nodes to interact with each other and ensure that both nodes are working with the same currency when verification operations (and other such functions) are performed. This allows different nodes to support payment in different currencies, and still be able to communicate payment information in a standardized fashion.

Nodes in a communication network involve both capital expenditure and ongoing operational expenses. Currently, there are limited ways to monetize a node including the owner of the node charging for bulk traffic over the node, or by having the node participate in a network which provides a service to end users that pay for the service. These models can be simple and effective for a defined business plan, but are not adaptable to more dynamic networking arrangements. When, as noted above, a network element is able to exchange payment information as part of a data transmission, a network element becomes more than just an operational expense, it can become a source of revenue. When the node participates in a transaction for which it charges a fee, whether that transaction is a cryptocurrency verification, a packet routing operation, or other such operation, the revenue generated can be fractionally attributed to different parties. Thus an equipment vendor may be able to reduce the cost of a network element for a share in future revenues generated by the node, a software vendor providing a service executed on the network element could adjust costs based on the promise of an ongoing payment, and financing companies can aid in obtaining funds for a network operator to upgrade the network based on the promise of a revenue stream derived from the nodes that are purchased. This flexibility can be enhanced by having the fractional attribution of the revenue take place by either the operator of the network element receiving the full payment and having a report generated at fixed intervals, or by having the network element itself immediately forward fractional payments for each transaction to the relevant third party or parties.

According to embodiments, there is provided a method for reconciliation of the use of resources of a network node by another entity, for example a requesting entity. As such, this method can enable a network node of a first network, for example the provisioning entity, to provide network services and network resources associated therewith, accessible for use by a second network, for example the requesting entity, for a particular cost. In some embodiments, the payment for use of the network services, network resources or both can be reconciled on the fly, namely on a per use basis. In other embodiments, the payment for use of the network services, network resources or both can be reconciled at predetermined intervals.

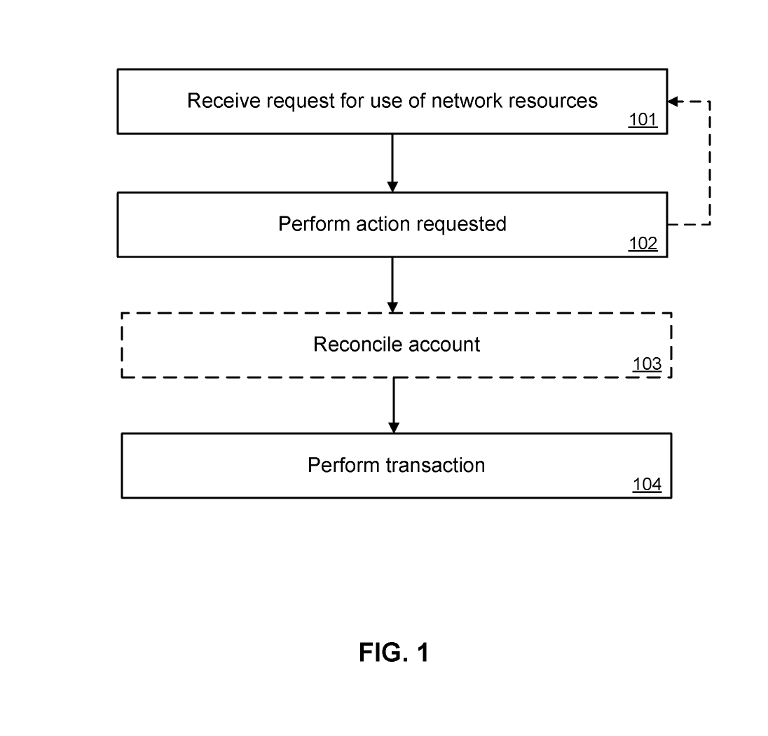

FIG. 1 illustrates a method for use of resources of a network node and reconciliation for use of same, in accordance with embodiments of the present invention. The method includes receiving 101 by a network node, a request for use of network resources. According to embodiments, a request for use of the network resources can be an explicit request or an implicit request. For example, an explicit request can be configured as request for service with an acknowledgment which subsequently indicates a cost of the requested network services. For example, an implicit request can be configured as a request which also includes an indication of an amount that the requesting device is willing to pay for the requested services.

According to embodiments, the network node subsequently performs 102 an action that is based at least in part on the request. The network node can subsequently perform 104 a transaction of digital currency based on an associated cost with the performance of the action. In some embodiments, the method further includes reconciling 103 an associated cost with the performance of the action prior to performing the transaction.

In some embodiments, a payment can be embedded in the data packet to be processed and transferred via the requested network resources. For example, the payment can be configured as a nano-digital currency payment or nano payment, that is embedded in the header of the packet. By the integration of payment within the data packet, the requesting entity can pay for the use of these network resources in real time and on the fly. In this manner, the requesting entity does not require a pre-registered or approved use agreement of the network resources, as the payment of use of the network resources is on an as used basis.

In some embodiments, the payment that is embedded in the data packet can be deemed to be the amount that the requesting entity is willing to pay a provisioning entity for the network resources that are required for performance of the action. As such, if the amount embedded within the packet is greater than a minimum cost which the network entity requires for performing the action, the “overpayment” can be deemed as a preauthorized request for a greater “quality of service” (e.g. faster delivery based on network resources used for performing the action) or preferential service (e.g. prioritized delivery) that may be provided.

In some embodiments, a payment can be embedded in the data stream at predetermined intervals or intervals selected by the requesting entity for use of the network resources. For example, the payment can be embedded in the header of every 1000^{th} data packet in the data stream. In this example, the transaction that is performed by the network node, can be performed at a predetermined interval, which can be aligned with the interval of embedded payments. In this manner, the resources that are required for the performance of the transaction can be reduced due to the reduction in the frequency thereof.

According to some embodiments, plural requests are received by the network node and plural actions based on the requests are performed before the reconciliation of the account is performed by the network node. In this manner, should a particular requesting entity require plural actions to be performed by the network node, the reconciliation and transactional payment can occur at a later time thereby mitigating intermediate payments. In this instance, the network node can maintain a ledger of actions performed and costs associated with same for later reconciliation and payment by the requesting entity.

According to some embodiments, the digital currency that is being used for payments by the requesting entity for use of the network resources of another entity, can be a common digital currency that is deemed for use between the requesting entity and the entity providing the network resources. This common digital currency can be solely for use between these two entities and the deemed value can be assigned thereby. Alternately, the common digital currency can be a designated currency defined by the entity that provides the network resources and that the requesting entities can be assigned or provided with amounts of the common currency for the payment of network resources to be subsequently requested. For example, the provision of the common digital currency can be envisioned as being synonymous with a casino chip, wherein that particular currency has a perceived value only when used in the particular casino, and in this instance the currency only has a value for payment of the use of network resources provided by the particular entity associated with the currency.

According to some embodiments, the transaction for payment of the services that have been provided can be performed upon completion of requests from a requesting entity, at predetermined intervals of time, upon the account for the requesting entity reaching a predetermined amount, or other predefined trigger for the transaction of digital currency to be performed.

According to some embodiments, the digital currency used for the transaction is based on a blockchain which is essentially an open distributed ledger that can record transactions between two parties efficiently and in a verifiable and permanent way. As such, the transaction can include the updating of the blockchain in order to confirm payment of the provisioning entity by the requesting entity. As previously discussed, the updating of the blockchain can be performed upon completion of requests from a requesting entity, at predetermined intervals of time, upon the account for the requesting entity reaching a predetermined amount, or other predefined trigger for the updating of the blockchain.

According to some embodiments, the requesting entity and the provisioning entity can predefine or predetermine an escrow agency or entity that can track the movement of digital currency between the requesting entity and the provisioning entity during performance of the requested actions. In this manner, upon completion of the requests, predetermined intervals of time or predetermined amounts, the escrow agency can be reconcile the accounts of the requesting entity and the provisioning entity to performed the required transaction for payment of the services that have been provide.

Further examples of network resources of a first network or network node being provided to a second network are defined below. It will be readily understood, if even necessary, how to modify the above discussed method of reconciliation and transactional payment in relation to the provision of resources by a network node discussed below.

In today's networks, a content provider may desire a certain quality of service on the network paths between the content provider's servers and the consumer of the content. This quality of service helps the content provider ensure a satisfied customer. As noted above, this is often addressed today through the use of peering agreements that may provide preferential service to different content providers. These agreements are static and do not account for the dynamic changes that many networks experience. With the ability of network nodes to receive digital payments for the transport of content streams, it is envisioned that a content provider can obtain ad hoc quality of service delivery guarantees from a variety of different network segments and then deliver the content to the user. These ad hoc quality of service guarantees can be paid for during the transaction with guarantees in place to ensure compliance. A content provider can change the delivery path of content to a particular user as the user either changes location in the network or as alternative routing paths become available and less costly.

As noted above, conventional peering agreements are typically useful for a content provider dealing with a network operator. However, as content providers make use of distributed networks, one particular network may benefit from access to another network. At present this is a difficult problem to monetize as the flow of traffic may fluctuate and change the burden that one network imposes on another. By allowing dynamic charging of digital payments, the resources of a first network element in a first network domain can be reserved by a service in a second network domain on a per transaction basis. One such example is that an extension to the Border Gateway Protocol could allow a gateway to apply a levy to incoming traffic from an Application Server (AS) in the second domain to traverse the first domain. As an AS in the first domain generates traffic that needs to traverse the second domain, a similar levy can be applied. These can be discrete operations which allows for different pricing based on time of day, congestion, and other related factors.

In conventional wireless networks, network operators spend large sums of money building both wired and wireless infrastructure. Typically different network operators build their own networks, or engage in pre-agreed network sharing arrangements. However, as loads in different cells of a network vary, and as users move from one location to another, need can arise for a first network operator to utilize the resources of a second network operator. As opposed to conventional roaming agreements, the need for resources may entail the use of particular resources in a second network such as antennae, spectrum allotments etc. Either the user or his service provider can make micropayments using digital currencies to the second network, which would allow for such results as the use of a second antenna to allow for beam forming or other such performance enhancements. Each network operator can determine the resources that it is willing to make available through such per-transaction payments, which may include core network services, backhaul access to a base station, modulation, RF transmitters and receivers, spectrum, and demodulation.

In many content delivery networks, content is cached near leaf nodes in a network. A content delivery network allows authorized users to access the cached content, but other users outside the content delivery network do not see the cached content. A network service provider may become aware of the availability of the content through seeing other data traffic requesting the content being delivered through a cache close to the user outside the content delivery network. At present, there is no mechanism for this cached content to be utilized for the benefit of the outside user. This not only results in the outside user not having access to the content but also in the network operator having to increase traffic across the network because the user does not have access to the cached content. Using digital payments, the network operator or the user can obtain one-off access to the cached content to improve the user experience or to reduce overall traffic on the operator network.

Many over-the-top (OTT) services require a certain degree of network infrastructure that can be expensive to deploy. Different OTT services could re-use infrastructure from existing OTT implementations, and in other cases network operators could make available nodes for use by OTT service providers. However, there is no incentive other than altruism for such sharing of resources. The use of digital micropayments can facilitate the development of a shared or distributed infrastructure which could, for example, provide put( )/get( ) rendezvous operations for OTT applications. Digital currency charging can be facilitated on a per put( )/get( ) basis to allow each provider of equipment or services to be compensated by the OTT service using the resource.

The discussion around payment for access to content is typically performed through bulk licensing arrangements, where the distributor of content pays the creator. However, with the rise of a more distributed content creation environment, content creators are turning their minds to how to ensure distribution of the created content. Digital payments for such distribution can be enabled by having a connection extending a common protocol, such as HTTPS, to allow for the content provider to securely transmit payment enabled content to the content distributor for preferential service or placement.

It should also be understood that with wireless communication links, the transmission of digital currency can be done over radio frequency links with payment information being contained at the RF encoding level instead of at a higher level. Thus users that are making use of radio based links can pay for improved service, or reduce what they pay by having a transactional relationship with the service provider.

It should also be understood that as wireless networks begin to use what would have formerly been seen as wireless terminals as wireless relays, the owner of a device that is to be used as a relay will often decide that it isn't worth losing battery life by having his device receive and transmit data that the user cannot himself use. As such, a mechanism is required that allows either the receiver of the data or the network operator to provide an incentive to the owner of the device being used as a relay. Digital payments are ideal for this scenario. The owner of a device can set various conditions under which he will allow the device to act as a relay. Each different scenario can have a different charging level. Thus a device could charge one fee when it is fully charged, or plugged into the wall to draw power, and another tariff level when it has 30% battery left. The payments can be made using digital currencies either on a user-to-user payment, or from the network operator to the user (where the user is probably less concerned as to whether the recipient of the data is paying the network operator or not).

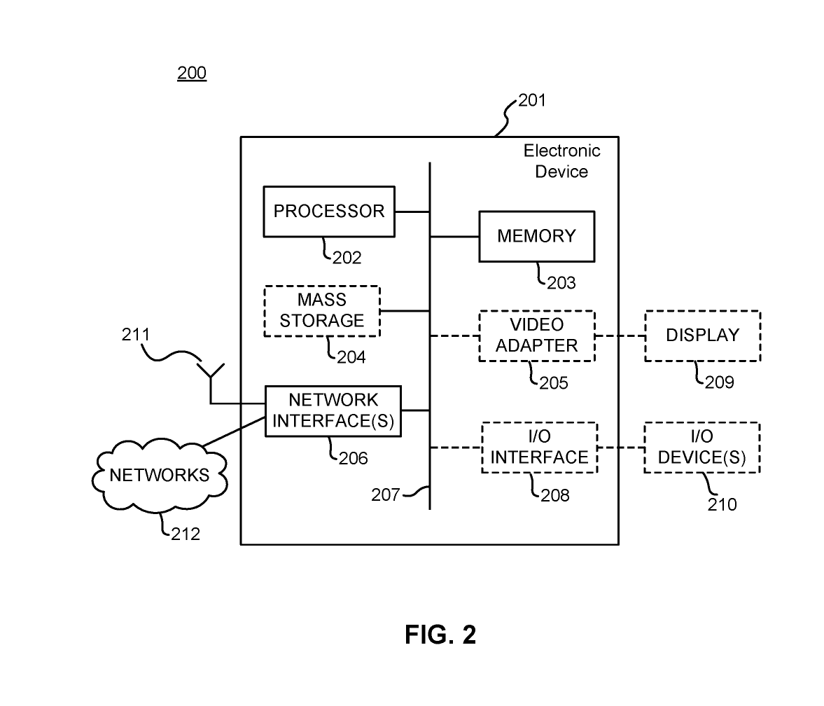

FIG. 2 is a block diagram of an electronic device (ED) 201 illustrated within a computing and communications environment 200 that may be used for implementing the devices and methods disclosed herein. It will be understood that an electronic device can also be referred to as a network node or simply a node. In some embodiments, the electronic device may be an element of communications network infrastructure, such as a base station (for example a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a public land mobility network (PLMN). In other embodiments, the electronic device may be a device that connects to the network infrastructure over a radio interface, such as a mobile phone, smart phone or other such device that may be classified as a User Equipment (UE). In some embodiments, ED 201 may be a machine type communications (MTC) device (also referred to as a machine-to-machine (M2M) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The electronic device 201 typically includes a processor 202, such as a central processing unit (CPU), and may further include specialized processors such as a graphics processing unit (GPU) or other such processor, a memory 203, a network interface 206 and a bus 207 to connect the components of ED 201. ED 201 may optionally also include components such as a mass storage device 204, a video adapter 205, and an I/O interface 208 (shown in dashed lines).

The memory 203 may comprise any type of non-transitory system memory, readable by the processor 202, such as static random access memory (SRAM), dynamic random access memory (DRAM), synchronous DRAM (SDRAM), read-only memory (ROM), or a combination thereof. In an embodiment, the memory 203 may include more than one type of memory, such as ROM for use at boot-up, and DRAM for program and data storage for use while executing programs. The bus 207 may be one or more of any type of several bus architectures including a memory bus or memory controller, a peripheral bus, or a video bus.

The electronic device 201 may also include one or more network interfaces 206, which may include at least one of a wired network interface and a wireless network interface. As illustrated in FIG. 2, network interface 206 may include a wired network interface to connect to a network 212, and also may include a radio access network interface 211 for connecting to other devices over a radio link. When ED 201 is a network infrastructure element, the radio access network interface 211 may be omitted for nodes or functions acting as elements of the PLMN other than those at the radio edge (e.g. an eNB). When ED 201 is infrastructure at the radio edge of a network, both wired and wireless network interfaces may be included. When ED 201 is a wirelessly connected device, such as a User Equipment, radio access network interface 211 may be present and it may be supplemented by other wireless interfaces such as WiFi network interfaces. The network interfaces 206 allow the electronic device 201 to communicate with remote entities such as those connected to network 212.

The mass storage 204 may comprise any type of non-transitory storage device configured to store data, programs, and other information and to make the data, programs, and other information accessible via the bus 207. The mass storage 204 may comprise, for example, one or more of a solid state drive, hard disk drive, a magnetic disk drive, or an optical disk drive. In some embodiments, mass storage 204 may be remote to the electronic device 201 and accessible through use of a network interface such as interface 206. In the illustrated embodiment, mass storage 204 is distinct from memory 203 where it is included, and may generally perform storage tasks compatible with higher latency, but may generally provide lesser or no volatility. In some embodiments, mass storage 204 may be integrated with a heterogeneous memory 203.

The optional video adapter 205 and the I/O interface 208 (shown in dashed lines) provide interfaces to couple the electronic device 201 to external input and output devices. Examples of input and output devices include a display 209 coupled to the video adapter 205 and an I/O device 210 such as a touch-screen coupled to the I/O interface 209. Other devices may be coupled to the electronic device 201, and additional or fewer interfaces may be utilized. For example, a serial interface such as universal serial bus (USB) (not shown) may be used to provide an interface for an external device. Those skilled in the art will appreciate that in embodiments in which ED 201 is part of a data center, I/O interface 208 and Video Adapter 1705 may be virtualized and provided through network interface 206.

In some embodiments, electronic device 201 may be a standalone device, while in other embodiments electronic device 201 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

Those skilled in the art will appreciate that the above described aspects and embodiments of the present invention allow for packets and packet flows sent from a first network to a second network to both request a QoS and to include an allotment of digital currency to allow for payment to the operator of the second network for the QoS support. Typically, traffic from a first network will be routed into a second network through one of a limited number of gateways. The methods discussed in the application can be carried out at such a gateway node, or they may be carried out at a node in a control plane of the second network. A gateway node of the second network may receive requests for a QoS for a packet or packet flow, and either determine the QoS that should be provided to the packet/packet flow or route the request to the relevant node

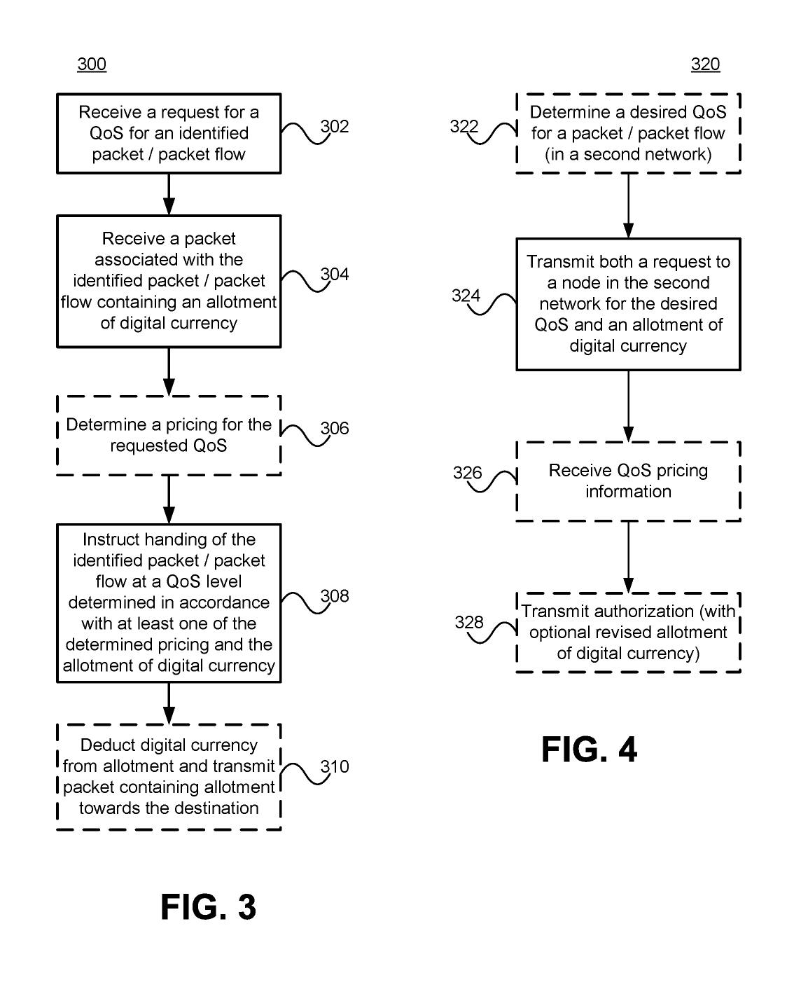

In one scenario, a packet/packet flow (hereafter simply referred to as a packet flow for simplicity) is sent from a first network into a second network, and the source of the packet flow (or an administrative entity associated with the source) wants to ensure that the packet flow is treated with a specific QoS in the second network. From the perspective of an entity within the second network (typically either a gateway in the second network or a node within the control plane of the second network), method 300 illustrated in FIG. 3 begins with the receipt of a request for a QoS for an identified packet flow in step 302. In step 304, a packet containing an allotment of digital currency, also associated with the packet flow is received. Those skilled in the art will appreciate that the packets received in 302 and 304 may be the same packet. In some embodiments, an optional step 306 is performed to determine pricing for the requested QoS. This pricing may, in some embodiments be fixed, which could negate the need to determine it at this point, or it could be variable. The variable pricing for the requested QoS may be dependent upon any or all of time of day, current network loading statistics, an existing agreement with the source of the packet flow, the size of the packet flow and other such factors. In step 308, an instruction is transmitted specifying that the identified packet flow be handled with a QoS level that is determined in accordance with at least one of the determined pricing and the allotment of the digital currency. It should be understood that if the pricing for a QoS level is dynamic, there is the possibility that the allotment of currency could either exceed the pricing, or that the pricing could exceed the allotment. If there is sufficient or excess currency in the transmitted allotment, the requested QoS level can be instructed in step 308, and in step 310, digital currency corresponding to the QoS pricing can be deducted from the allotment, and if there are further networks through which the packet flow has to traverse, the packet containing the diminished allotment can be sent towards the destination. If there is insufficient digital currency in the allotment, the QoS instructed in step 308 may be determined by the amount of currency available instead of the QoS requested. In effect, this would allow the best QoS possible for the currency provided. In another embodiment, if there is insufficient currency in the received allotment, a message can be sent back to the packet flow source (or a corresponding administrative entity) with at least one of a proposed QoS or an indication of the price of the requested QoS. In response to such as transmission, either the request for a QoS received in 302 or a revised allotment to replace or supplement the allotment received in 304 may be received, and the process can continue to step 308.

At a network node or function within the first network, according to method 320 of FIG. 4, it can be determined, in step 322, that a packet flow should be provided with a desired QoS in a second network. A request for the desired QoS, and an allotment of digital currency, can be transmitted to a node in the second network in step 324. It should be understood that this may be done in a single transmission, or the currency can be transmitted separately from the request (e.g. in a separate packet). In some embodiments one or both of the request and the currency can be embedded in the header of a packet of the flow, while in other embodiments they can be sent in the payload of a specific administrative packet. In some embodiments, in optional step 326, information about QoS pricing is received from the second network. This is typically received in response to a mismatch in the requested QoS level and the allotment of digital currency transmitted in 324. In optional step 328, an authorization for a different QoS level (which may include a revised allotment of digital currency) is transmitted.

In some embodiments, there are a plurality of different networks traversed by a packet flow. Variations of the above methods can be used to request different QoS levels in each of the different networks. From the packet flow source, a request for a QoS level in each of a plurality of networks can be sent. This can take the form of individual requests, each providing an indication of a packet flow identifier, or it can be included in a packet header that is then modified by each of the networks in series. The allotment of digital currency can be divided up so that each network has a different allotment (and possibly a different type of digital currency), while in other embodiments a single combined allotment can be provided.

At the gateway or control node of the second (or subsequent) network, the request received may be one of a plurality of different requests. One of the plurality will be associated with the second network, while others are associated with subsequent networks. The request for a QoS level may also include an indication of the portion of the allotment that the second network is authorized to deduct. This ensures that an early network does not disproportionately consume the allotment resulting in poor service in later networks.

It should be understood, that as discussed above, the allotment of digital currency may take the form of a set of tokens. These tokens can be exchanged between two networks, and then reconciled at specified times. The reconciliation may be driven by a timing process so that it happens at regular time intervals. Reconciliation may be driven by a data flow metric so that it occurs if a predetermined amount of data is exchanged between the networks. Reconciliation may be driven by a balance function so that it occurs when the amount of traffic sent from one network to the other exceeds the traffic in the other direction by a predefined threshold. The reconciliation may also occur when one of the two networks has accumulated a predefined quantity of the tokens/digital currency. When there is a plurality of networks for a data flow to traverse, each of the networks may have a different token so that no network has an incentive to take the tokens intended for a different network.

Digital tokens may be signed by the sender, but not need to be verified by a full block chain in some embodiments. The degree to which cryptographic trust has to be relied upon may be a function of the number of parties that use the tokens, and the level of trust between the parties. In some examples, two large network operators may trust each other and simply exchange tokens that do not include cryptographic properties.

It should be noted that the ability to vary the price for different QoS levels allows large scale peering agreements to accommodate differential pricing, so that it is not simply a question of trading carriage of a packet for carriage of a packet. Considering delivery of a packet flow according to the QoS is important, the value of ensuring a QoS level for a packet flow, when the network carrying the flow is heavily loaded, may be greater than the value of delivering best effort traffic during a period in which the network is lightly loaded. Thus, a more equitable version of peering can be provided.

Those skilled in the art will appreciate that the above embodiments can be implemented in isolation or in combination with each other. Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for reconciliation of use of resources of a network node, the method comprising:
receiving, by the network node, a request for use of network resources;
performing, by the network node, an action based at least in part on the request; and
performing, by the network node, a transaction of digital currency based on an associated cost for performance of the action.

2. The method according to claim 1, further comprising reconciling, by the network node, the associated cost with the performance of the action prior to performing the transaction.

3. The method according to claim 1, wherein the request includes a data packet for transmission and wherein digital currency is embedded in a packet header of the data packet.

4. The method according to claim 3, wherein the data packet is a portion of a data stream and wherein the digital currency is embedded in packet headers of data packets at predetermined locations within the data stream.

5. The method according to claim 1, wherein the digital currency is selected by a requesting entity and a provisioning entity, the provisioning entity including the network node.

6. The method according to claim 1, further comprising distributing, by the network node, a fractional amount of received digital currency to a third party.

7. A network node comprising:
a processor; and
a non-transient memory for storing instructions that when executed by the processor cause the network node to be configured to:
receive a request for use of network resources;
perform an action based at least in part on the request; and
perform a transaction of digital currency based on an associated cost for performance of the action.

8. The network node according to claim 7, wherein the instructions, when executed by the processor further cause the network node to be configured to reconcile the associated cost with the performance of the action prior to performing the transaction.

9. The network node according to claim 7, wherein the request includes a data packet for transmission and wherein digital currency is embedded in a packet header of the data packet.

10. The network node according to claim 9, wherein the data packet is a portion of a data stream and wherein the digital currency is embedded in packet headers of data packets at predetermined locations within the data stream.

11. The network node according to claim 7, wherein the instructions, when executed by the processor further cause the network node to be configured to distribute a fractional amount of received digital currency to a third party.

12. A method of determining a Quality of Service (QoS) for a packet flow in a network, the method comprising:
receiving a request for a QoS for an identified packet flow;
receiving an allotment of digital currency associated with the identified packet flow; and
instructing nodes within the network to provide the packet flow with a QoS determined in accordance with at least one of a determined pricing for the requested QoS and the allotment of digital currency.

13. The method of claim 12 wherein the request for a QoS and the allotment of digital currency are received in the same message.

14. The method of claim 12 wherein at least one of the request for a QoS and the allotment of digital currency are received in the header of a packet in the identified packet flow.

15. The method of claim 12 further comprising determining a pricing for the requested QoS in advance of instructing.

16. The method of claim 15 further comprising transmitting a notification that the received allotment is lower than the determined pricing.

17. The method of claim 12 further comprising deducting digital currency from the allotment and transmitting a packet containing a remaining allotment towards a destination of the packet flow.

18. A method, for execution by an entity within a first network, of requesting a quality of service for a packet flow in a second network, different than the first network, the method comprising:
transmitting, to a node in the second network, a request for a quality of service (QoS) for an identified packet flow; and
transmitting, to the node in the second network, an allotment of digital currency associated with the request.

19. The method of claim 18 wherein the node in the second network is a gateway.

20. The method of claim 18 wherein the node in the second network is within a control plane of the second network.

21. The method of claim 18 wherein the request and the allotment are transmitted in the same packet.

22. The method of claim 18 wherein at least one of the request and the allotment are transmitted in a header of a packet in the identified packet flow.

23. The method of claim 18 further comprising receiving from a node in the second network pricing information associated with the QoS requested for the identified packet flow.

24. The method of claim 23 further comprising transmitting at least one of a revised request for a QoS and a revised allotment of digital currency.

25. The method of claim 24 wherein the at least one of the revised request and the revised allotment are contained in an authorization message.
